(19) United States
(12) Patent Application Publication
(10) Pub. No.: US 2014/0162353 A1
(43) Pub. Date: Jun. 12, 2014

(54) FLUID SEGMENT SAMPLING DEVICE

(71) Applicant: BIOMEDICAL POLYMERS INC., Gardner, MA (US)

(72) Inventor: Michael T. Faulkner, Leominster, MA (US)

(73) Assignee: BIOMEDICAL POLYMERS INC., Gardner, MA (US)

(21) Appl. No.: 13/712,298

(22) Filed: Dec. 12, 2012

(51) Int. Cl. G01N 1/10

(52) U.S. Cl. CPC G01N 1/10
USPC 435/309.1

(57) ABSTRACT

A fluid segment sampling device and method wherein a housing includes an input port configured to receive a segment tube, an output port configured for a receptacle, a passageway between the input port and the output port, and a side port leading into the passageway. A blade unit is insertable in the side port to cut a segment tube inserted into the input port.

### FIELD OF THE INVENTION

Embodiments herein relate to blood collection, segment devices, and/or sampling devices.

### BACKGROUND OF THE INVENTION

Hospitals and blood banks typically employ a blood collection bag connected to flexible plastic tubing. After a collection of blood from a patient or donor, the tubing is heat sealed into a series of sealed segments containing the donor's blood.

During type and cross-matching procedures, a sealed segment is pierced and the blood therein transferred into a test tube or other receptacle. See, U.S. Pat. No. 7,153,386 incorporated herein by this reference.

Various segment devices are available for transferring blood in a segment to a test tube. U.S. Pat. No. 7,153,386, for example, discloses a plastic housing with a metal needle secured therein by an adhesive. The “TypeSafe” (Typenex Medical, LLC) segment sampling device is similar. Other devices include the “SE& SAFE” segment processor (Alpha Scientific Corp.)

The resulting cost of such devices can be fairly high. Also, the needle used to pierce the segment can result in damage to or destruction of cells present in the blood.

### SUMMARY OF THE INVENTION

Presented in one preferred example is a new segment sampling device made entirely out of plastic to reduce costs and to simplify manufacturing. The segment piercing device is preferably configured to limit damage to or destruction of cells present in the blood. In one version, the device includes a blade unit received in a side port of the device.

Featured is a fluid segment sampling device comprising a housing and a blade unit. The housing preferably includes an input port configured to receive a segment tube, an output port configured for a receptacle, a passageway between the input port and the output port, and a side port leading into the passageway. The blade unit is insertable in the side port to cut a segment tube inserted into the input port. The output port may have a conduit receivable in a test tube.

In one design, the input port includes an opening configured with opposing squared off ends. One preferred side port defines an angled channel into the passageway. The channel may extend into the housing beyond the passageway and the blade unit then includes a blade having a length sufficient to extend into the channel beyond the passageway.

One blade unit includes a grooved blade extending from a handle, a shank portion receivable in the side port, and a stop member not receivable in the side port. The shank may be disposed within the side port positioning the blade tip proximate the passageway.

Preferably, all the components of the sampling device are molded from a plastic material.

A method of manufacturing a fluid segment sampling device may comprise molding a housing out of plastic to include an input port configured to receive a segment tube, an output port configured for a receptacle, a passageway between the input port and the output port, and a side port leading into the passageway. A blade unit is molded from plastic and is configured to be insertable in the side port with a blade extending at least partially into the passageway. The input port can be molded to include an opening configured with opposing squared off ends and side port molded to define an angled channel into the passageway.

Also featured is a method of sampling blood from a fluid segment comprising placing a fluid segment in an input port of a housing and at least partially into a passageway between the input port and an output port, associating the output port with a receptacle, and pushing on a blade unit in the side port of the housing and urging a blade of the blade unit into the passageway to cut the fluid segment. Preferably, the blade of the blade unit is driven through the fluid segment.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic cross sectional view showing an example of a prior art segment sampling device;

FIG. 2 is a schematic three dimensional view showing an example of a fluid sampling segment device in accordance with the invention;

FIG. 3 is a schematic cross sectional view of a portion of the device of FIG. 2;

FIG. 4 is a schematic three dimensional view showing an example of a blade unit in accordance with the invention;

FIG. 5 is a schematic three dimensional top view of another example of a fluid sampling segment device in accordance with the invention;

FIG. 6 is a cross sectional view taken along lines 6-6 of FIG. 5; and

FIG. 7 is a schematic three dimensional front view of a sampling device shown in FIGS. 5-6.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

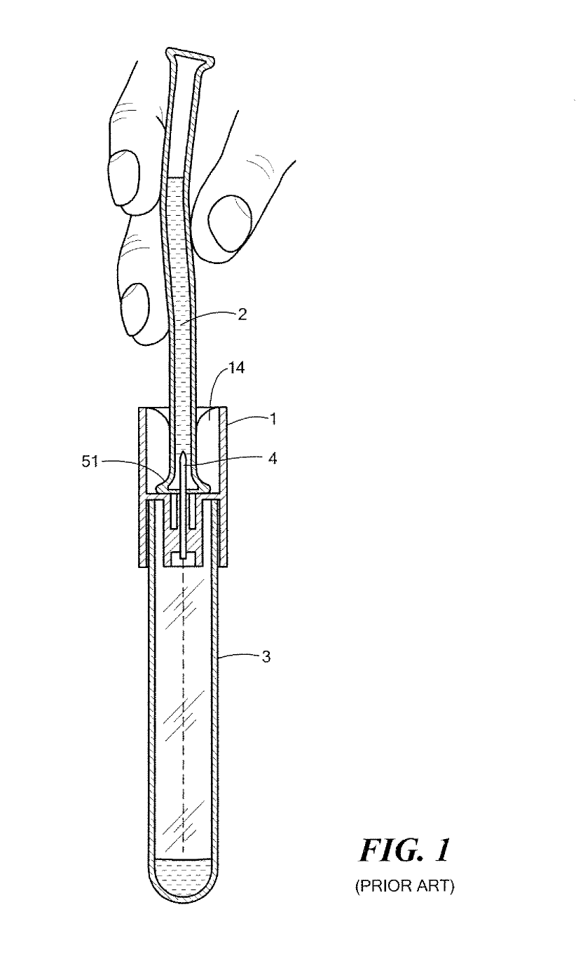

FIG. 1 shows a sampling device 1 for transferring blood from segment 2 to test tube 3. The device includes metal needle 4 therein. See U.S. Pat. No. 7,153,386 incorporated herein by this reference. As noted in the background section above, the resulting cost of such devices can be fairly high. Also, the needle used to pierce the segment can result in damage to or destruction of cells present in the blood.

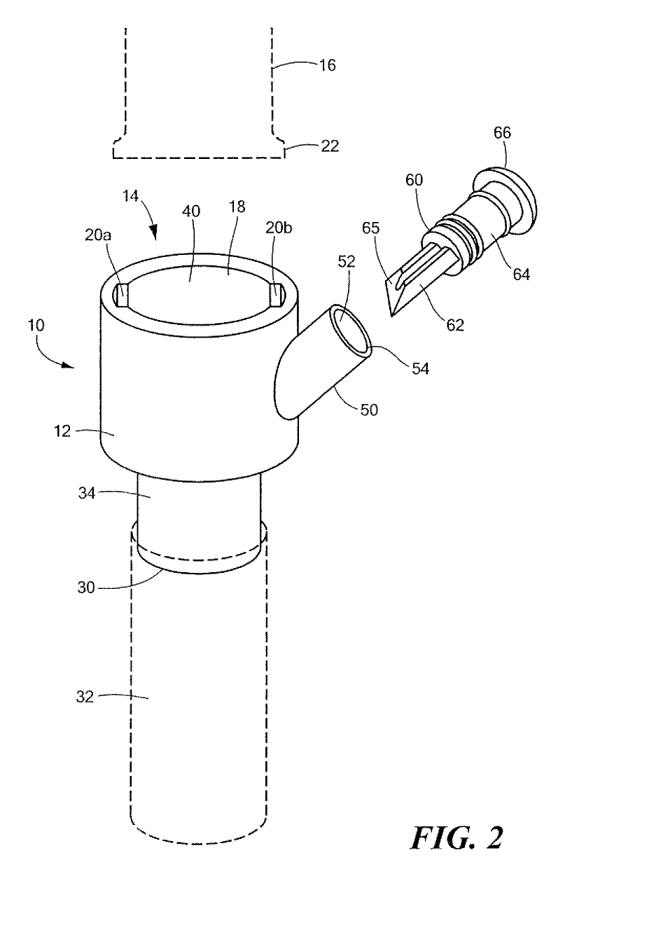

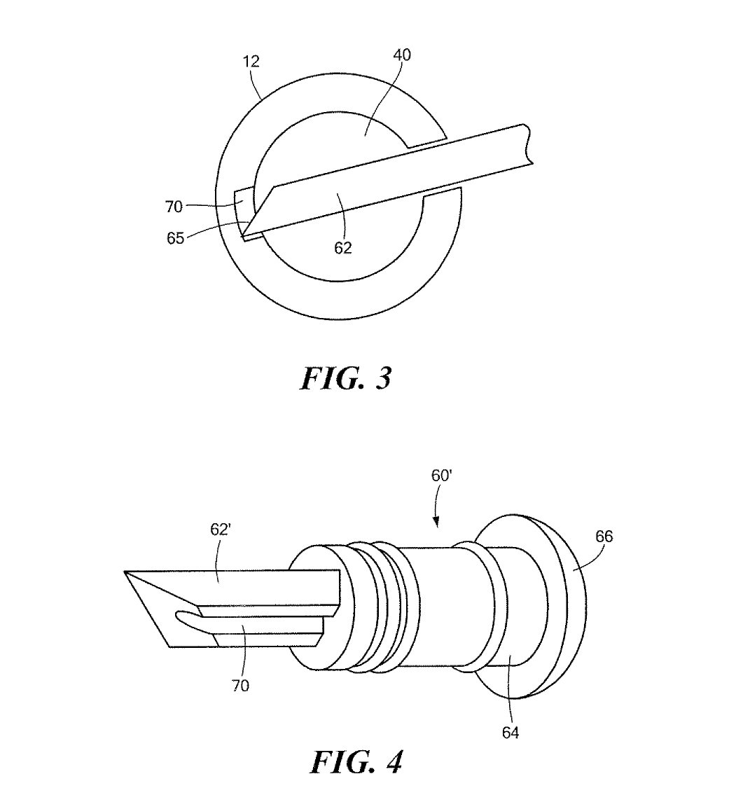

FIG. 2 shows a new fluid segment sampling device 10 with housing 12 defining an input port 14 configured to receive one end of a segment (tube) 16. Opening 18 is preferably configured with opposing squared off ends 20a and 20b and thus is configured like the typically squared off heat sealed end 22 of segment 16.

Output port 30 is configured for receptacle 32 (e.g., a typical test tube) and preferably includes conduit 34 size to be received in the open end of the receptacle as shown. Housing 12 may include a skirt portion spaced about conduit 34 and sized to fit over the open end of the receiving receptacle. A passageway 40 (see also FIG. 2) extends between the input 14 and output 30 ports.

Side port 50, preferably with downwardly angled channel 52, leads into the passageway between the input and output ports and receives therein blade unit 60. When segment 16 is urged down into passageway 40, blade unit 60 is pressed into the side port and cuts into the side of the segment tube. Blood then enters collection receptacle 32 from output port 34.

One preferred blade unit includes blade 62 with angled tip 65 extending from handle shank 64 configured to be received within side port 50 channel 52. Handle stop number 66 is too large to be received in the side port. Blade 62 is preferably long enough such that when stop member 66 abuts the top rim 54 of side port 50, the tip 65 of blade 62, FIG. 2 extends across passageway 40 and into the portion 70 of channel 52 beyond passageway 40. In this way, the segment tube side wall is cut twice in opposing locations.

In use, it is preferred that the user receives the device with the blade unit 60 partially inserted into the side port positioning the tip of the blade just shy of the housing channel. Then, after a segment tube is positioned in the channel the user pushes stop member 66, FIG. 1 fully in to cut the tube segment, preferably cutting through the segment.

Preferably, all the components are plastic and can be molded using one mold for the housing and one mold for the blade unit. In one example, the blade unit is made of polycarbonate and the housing is made of high density polyethylene. Costs are reduced since no metal parts are needed and assembly is simplified. The result in one preferred embodiment is an inexpensive, disposable product. Because fairly large cuts are made in one or more sides of the segment tube, cell damage or destruction is minimal. Use of the device is easy and self evident or nearly self evident.

FIG. 4 shows one particular blade unit 60′ with angled blade 62′ and grooves 70. The groove allows blood from the segment tube to bypass the blade.

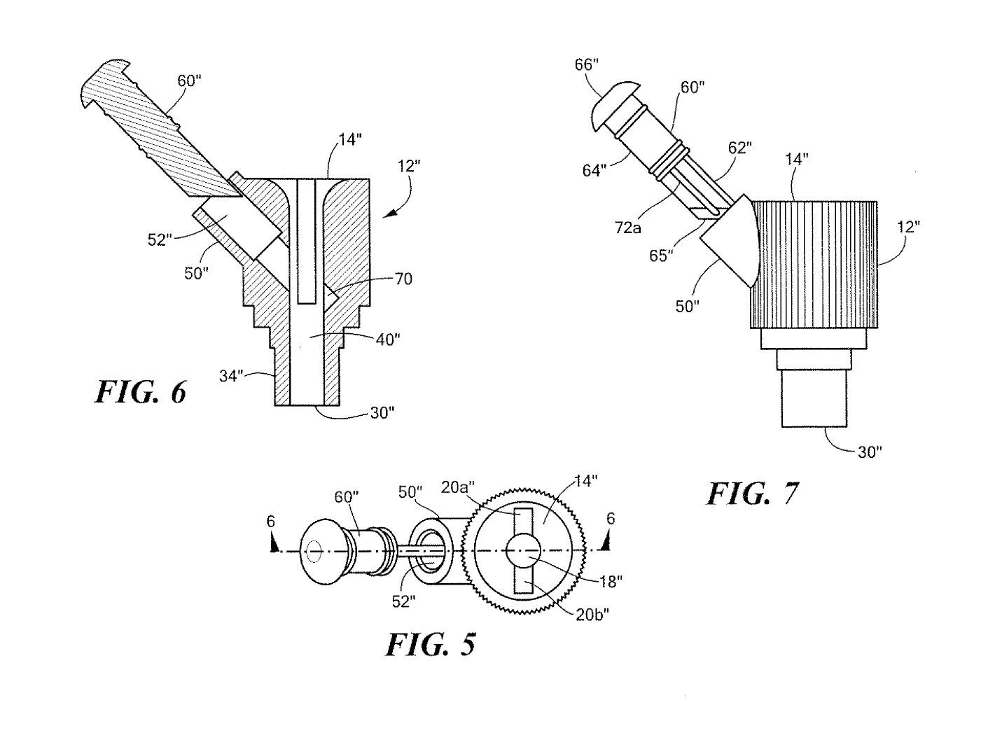

FIGS. 5-7 show another design with housing 12″ and blade unit 60″. Housing 12″ includes input port 14″, output port 30″, and passageway 40″ therebetween. Side port 50″ channel 52″ leads into and extends beyond passageway 40″ as shown at 70. Blade unit 60″ is also shown and here includes blade 62″ with side grooves as shown for side groove 72a.

Thus, although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A fluid segment sampling device comprising:
a housing including:
an input port configured to receive a segment tube,
an output port configured for a receptacle,
a passageway between the input port and the output port, and
a side port leading into the passageway; and
a blade unit insertable in the side port to cut a segment tube inserted into the input port.

2. The device of claim 1 in which the input port includes an opening configured with opposing squared off ends.

3. The device of claim 1 in which the side port defines a channel into the passageway.

4. The device of claim 4 in which said channel is angled.

5. The device of claim 3 in which the channel extends into the housing beyond the passageway.

6. The device of claim 5 in which the blade unit includes a blade having a length sufficient to extend into the channel beyond the passageway.

7. The device of claim 1 in which the output port has a conduit receivable in a test tube.

8. The device of claim 1 in which the blade unit includes a blade extending from a handle.

9. The device of claim 8 in which the handle includes a shank portion receivable in the side port.

10. The device of claim 9 in which the handle further includes a stop member not receivable in the side port.

11. The device of claim 9 in which the shank is disposed within the side port positioning the blade tip proximate the passageway.

12. The device of claim 1 in which all the components of the sampling device are made of a plastic material.

13. The device of claim 12 in which all the components of the sampling device are molded.

14. The device of claim 1 in which the blade unit includes a blade with a groove therein.

15. A method of manufacturing a fluid segment sampling device, the method comprising:
molding a housing out of plastic to include:
an input port configured to receive a segment tube,
an output port configured for a receptacle,
a passageway between the input port and the output port, and
a side port leading into the passageway; and
molding a blade unit out of plastic, the blade unit configured to be insertable in the side port and including a blade extending at least partially into said passageway.

16. The method of claim 15 further including the step of partially inserting the blade unit into the side port.

17. The method of claim 15 in which the input port is molded to include an opening configured with opposing squared off ends.

18. The method of claim 15 in which the side port is molded to define a channel into the passageway.

19. The method of claim 18 in which said channel is angled.

20. The method of claim 18 in which the channel extends into the housing beyond the passageway.

21. The method of claim 20 in which the blade unit includes a blade having a length sufficient to extend into the channel beyond the passageway.

22. The method of claim 15 in which the output port is molded to define a conduit receivable in a test tube.

23. The method of claim 15 in which the blade unit is molded to include a blade extending from a handle.

24. The method of claim 23 in which the handle further includes a shank portion receivable in the side port.

25. The method of claim 24 in which the handle further includes a stop member not receivable in the side port.

26. The method of claim 15 in which molding the blade unit includes forming at least one groove in the blade.

27. A method of sampling blood from a fluid segment, the method comprising:
placing a fluid segment in an input port of a housing and at least partially into a passageway between the input port and an output port;
associating the output port with a receptacle; and
pushing on a blade unit in a side port of the housing and urging a blade of the blade unit into the passageway to cut the fluid segment.

28. The method of claim 27 in which the output port has a conduit placed into a test tube.

29. The method of claim 26 in which the blade of the blade unit is driven through the fluid segment.
